(19) United States
(12) Patent Application Publication
(10) Pub. No.: US 2002/0032092 A1
(43) Pub. Date: Mar. 14, 2002

(54) Combination of flywheel and cylinder internal combustion engine with dynamotor, clutch and transmission

(76) Inventor: Tse-Cheng Wang, Taipei (TW)

Correspondence Address: Tse-Cheng Wang, 5333 Park Highlands Blvd., #28, Concord, CA, 94521, US

(21) Appl. No.: 09/884,298

(22) Filed: Jun. 20, 2001

(30) Foreign Application Priority Data
Jun. 21, 2000 (TW) 089112349

(51) Int. Cl. B60K 6/02

(52) U.S. Cl. 475/9

(57) ABSTRACT

This is a new invented combination of an Engine with Dynamotor, Clutch and Transmission. The Engine is constructed by the main parts of the flywheel and cylinder, on the circumference of the flywheel is built a double-layer wall, to carve two channels on the two contrast surface of the walls, to form cylindrical cam, a pin with two bearings mounted on the two ends of the pin, the bearings are inserted into the channels and running in the channel, the pin is through a hole of one end of the push rod, another hole on the other end of this rod with a pin to connect piston, the piston is moved in the cylinder, The flywheel is hollowed and arrange a Dynamotor in it. A reverse and neutral gear chamber is provided next to the Engine and Dynamotor chamber, in this chamber contains gears for shifting. Next the reverse and neutral gear chamber is the Clutch chamber, in this chamber is contained a Fluid Clutch. Next to this chamber is a Transmission, to shift the gears by controlling the bevel gears with brake drum or ratchet wheel. A case is covered all of these parts, formed the Combination. The function of this combination are an Engine, Dynamotor, (generator and motor), Clutch and Transmission. The Engine and the dynamotor will use as a fuel cell. All the units of this Combination may used independently.

### BACKGROUND OF THE INVENTION

This invention is a group of independent machine units combined together, to develop the best function and conveniently to use. The engine and dynamotor are combined together, the functions are as a Fuel Cell, a Generator, a Motor and an Engine to drive a car or things needed to drive, with the Engine or Motor, to charge the batteries with the Generator. They are controlled by the overdrive clutch and brake system. A chamber of gears, it can shift the gears in neutral, contacting and reverse gear positions. A clutch chamber, placed a fluid clutch in it, it will give a function of connecting or dividing. A transmission is provided, it will give a function of speed change. The prior arts have to place these units are separately. Especially, the Engine and the Transmission are new invented. The efficiency of the Engine is much higher than the reciprocating and rotary (wankel's) Engines. The Transmission is that the construction is much simpler, the function is much better, and flat disc shape save space.

### A BRIEF DESCRIPTION OF THE FIGURES

FIG. 1. The section of this combination.

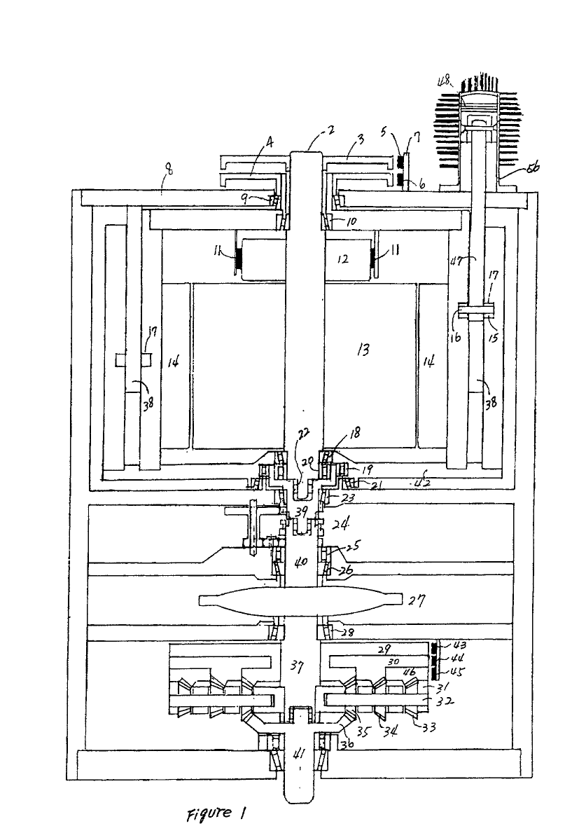

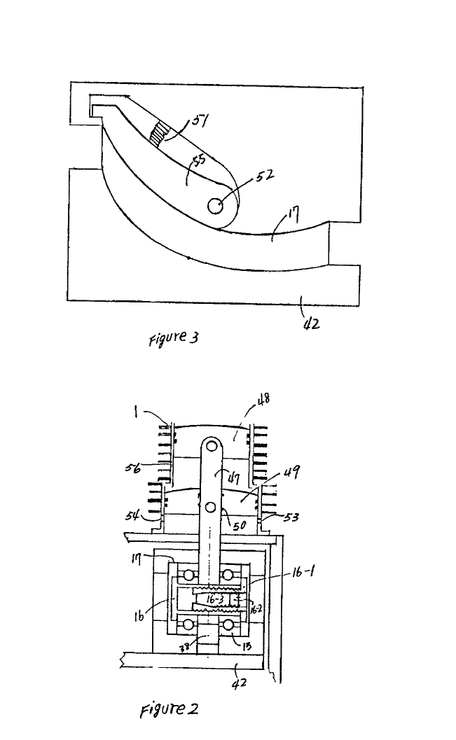

The numbers are represented:

1.The cylinder. 2.The shaft of dynamotor rotor. 3 The brake drum of dynamotor rotor to engage this brake drum to stop the dynamotor rotor. 4.The brake drum of engine rotor, (cylindrical cam) to brake this brake drum to stop the engine.5.The lining band of the dynamotor brake drum.6.The lining band of engine bake drum.7. The lining bands bracket. 8. The end plate. 9. The bevel roller bearing of the engine rotor (the cylindrical cam). 10. The bevel roller bearing of the dynamotor shaft. 11. The carbon brush and its bracket. 12. The commutator of the dynamotor. 13.The rotor of the dynamotor.14. The field of the dynamotor. 15 The bearing of the rod pin.16. The pin. 17. The channel of the rotor (cylindrical cam). 18. The bevel roller bearing of the dynamotor rotor shaft. 19. The overdrive clutch of the engine rotor (cylindrical cam) and the transfer shaft (39). 20. The overdrive clutch of dynamotor rotor shaft and the transfer shaft (39). 21. The bevel roller bearing of the engine rotor (42). 22. The roller bearing of dynamotor shaft (2) 23. The bevel roller bearing of the transfer shaft (39). 24. The reverse and neutral gearbox (the fork is omitted). 25. The roller bearing of transfer shaft (40). 26. The bevel bearing of the transfer shaft (40) connected to the upper half of the fluid clutch. 27. The fluid clutch assembly. 28. The bevel roller bearing of transfer shaft (37). 29. The 1^{st} gear and its brake drum to brake this brake drum the transmission in the 1^{st} gear position. 30 The bevel gear and its brake disc, to brake this disc the transmission is in 2^{nd} gear. 31 The bracket wheel, the pinion bevel gear and its shaft (32) are mounted on this wheel. 32. The shaft of pinion bevel gear. 33.The pinion bevel gear of 3^{rd} gear. 34. The pinion bevel gear of 4^{th} gear.35.The pinion bevel gear of 1^{st} gear.36. The driven bevel gear. 37.The transfer shaft of the fluid clutch down half cup. 38. The guide plate to guide the push rod in its right position. 39. The transfer shaft to transfer the power from engine or motor to the reverse and neutral gearbox (24). 40.The transfer shaft to transfer power from reverse and neutral gear box to the upper half of the clutch (27). 41. The output shaft. 42. The rotor of the engine (cylindrical cam). 43. The brake lining band for brake drum (29). 44. The brake lining band for brake drum (30). 45.The brake lining band for brake drum (46). (47) The pushing rod. (48) The piston.

FIG. 2. The detail installation of the flanged pin and air pressor devices.

The numbers are represented:

1. The cylinder. 15. The bearing. 16. The flange pin. 16-1. The hollow bolt. 16-2. The stop or lock screw. 16-3. The taper screw. 17.channel.38. The channel guide plate. 42. The flywheel. 47. The pushing rod. 48. The piston. 49. The piston of Air compressor. 50. The seal. 53. The inlet check valve of Air compressor. 54. The out let valve of Air compressor.

FIG. 3. The buffer device.

The numbers are represented:

17. The channel. 42. The flywheel. 51. The spring. 52. The pivot pin. 55. The buffer body.

### THE DETAILED DESCRIPTION

The Engine

The main purpose of this Engine is to increase the efficiency of the Engines, the efficiency of the reciprocating and the rotary (Wankel's) Engines are very low. The cause of the low efficiency of the reciprocating Engines are that when the effective pressure is higher or highest, the effective arm of the force is very short, even to zero (When the piston on T.D.C.). When the arm of the force is longer then or equal to r (the length of crank arm), the effective force will reduce to around 10% only. The effective force and the effective arm of the force are not matched. The cause of low efficiency of the rotary Engines is that a part of the force is pushing the rotor to one direction, the other pushes the rotor to the reverse direction. In F. & C. Engine the effective arm is the diameter of the flywheel. It is constant. It never be a zero, it is solved the question of varied effective arm of the force, The effective force is changed according to volume change of the cylinder. It is no connecting rod swing; no compressing and exploding impacting surface, reduce the frictional loss. The force direction is turning to one direction only. May a discount to the curvature, So, the efficiency of F & C. Engine is much higher than the reciprocating and the rotary Engines. This Engine mainly is built with flywheel and cylinder, (here after abbreviated as F & C. Engine.) The main parts of this Engine are the Flywheel (cylindrical cam), the Cylinder, the Guide channel plate, for guiding the push rod in its correct position, the engine case and other necessary accessories.

The Flywheel

There is a double-layer wall along the circumference of the Flywheel, on the walls to carve curve or inclined plane channels (grove), formed a cylindrical cam. Double-layer wall is better, for it holds the pushing rod in balance condition when the curve or the inclined plane of the channels is too steep. The upper surfaces of the channels will produce a impacting load and will need a buffer device, otherwise it will need to use the compressed Air to start the engine, and an Air system to reduce the impacting load to maintain the pressure inside the cylinder. But the system is complex. A hole drilled on around the center of the channel of the out side wall for install the pin into the pushing rod and the bearings. On the top end of this flywheel is mounted a top plate. On the center part of the top plate is mounted a hollowed center shaft. Inside the hole of this hollowed center shaft is mounted a bearing. The center shaft of the Dynamotor is passing through the center hole of the bearing. The outer side of this hollowed center shaft is mounted a bigger bearing. This hollowed center shaft is passing through the center hole of this bearing. The out side of this bearing is holt by a case mounted on the top plate of the Engine and the dynamotor chamber. Further upper part of this hollowed center shaft is mounted a brake drum. Out side of this brake drum is mounted a set of brake band and bracket that is fixed on the top plate of the chamber of Engine and Dynamotor. At the bottom end of the flywheel is mounted a bottom plate. A bearing case is fixed on the central part of the bottom plate. In this bearing case is mounted an overdrive clutch. In the center hole of this overdrive clutch is installed a transfer shaft from the chamber of reverse and neutral gear. The outer race of this overdrive clutch is mounted in a bearing case, which fixed on the bottom plate of this flywheel. A bigger bevel roller bearing is mounted in a bearing case. The bearing case is built on the central part of the bottom plate of the flywheel. The inside of the bigger bevel bearing is mounted on a tube size seat. The bevel roller bearing is supporting the whole flywheel, and the seat is built on the lower plate of the chamber of Engine and Dynamotor. Further away from the center there is some supporting rollers to support and guide the flywheel in its normal position.

The Cylinder

On the top of this cylinder is mounted a cylinder head. On this cylinder head is arranged with some holes for nozzle, spark plug, valve and the necessary accessories. Inside the cylinder arranged a piston with rings, pin, and push rod. Under the piston is another piston or elongate the piston and add some pieces of piston rings for the Air compressor. It has enough room for arranging a piston and a sleeve or to elongate the sleeve of the cylinder for the compressor because the push rod is moving straight and does not swing. The pushing rod, one end is connected to the piston with a pin; the other end is a hole with a pin passing through it. On the both ends of the pin are mounted bearings. The bearings are inserted into the channels respectively to transfer the force (pressure) from the piston by the pushing rod to the channels, and to turn the flywheel into running.

The Dynamotor

On the top end of the rotor of dynamotor is mounted a commutator. Out side of the commutator is a set of carbon brush and its bracket. The set of carbon brush and its bracket are fixed on the top plate of the Engine and the Dynamotor. In the center of the rotor of dynamotor is mounted a center shaft. The lower end of the shaft is inserted into a bevel roller bearing. The bottom plate of the flywheel holds the bevel roller bearing. The bevel roller bearing is supporting the rotor of the dynamotor for running. Further bottom part of this center shaft is inserted into overdrive clutch inner race. The outer race of the overdrive clutch is holding by a transfer shaft from the reverse and neutral chamber. The upper end of this center shaft is passing through a bearing. This bearing is holding by the top plate of flywheel to guide this center shaft in the center position. The farther upper part of this center shaft is mounted a brake drum. The out side of this brake drum is a set of brake lining band and bracket they are fixed on the top plate of the Engine and the Dynamotor, for controlling the rotor of the dynamotor. The field of the dynamotor is mounted on the inner part of the wall of flywheel. The circuit of the dynamotor will design by necessary.

The Reverse and neutral gear chamber

Inside this chamber are gears. One gear is fixed on the transfer shaft from the Engine and the Dynamotor chamber. A double gear, mounted with a shaft, is for changing the rotary direction. An idler gear to mesh with one end gear of the double gear. A slide gear is mounted on the transfer shaft from the clutch chamber, for shifting the reverse, neutral and contacting, by sliding.

The Clutch chamber

Inside this chamber is installed a pair of fluid clutch. The transfer shaft drives the upper piece from the reverse and neutral gear chamber. The lower piece is mounted on and driving the transfer shaft from transmission.

The Transmission

This transmission is a new invention. There are many encased bevel gears. Each bevel gear is fixed a brake drum or a ratchet wheel together. The out side of the brake drum or ratchet wheel is many sets of brake band or ratchet wheel stopper and its bracket. They are fixed on the top plate of the transmission. To engage the brake drum or ratchet wheel for shifting. The brake drum or ratchet wheel is engaged when the gear is in. The bevel gears are hollowed as a sleeve or tube encased from center to outer. Small bevel pinion gears are fixed on axes. The axes are mounted on a bracket. The bracket is driving by the transfer shaft from the lower piece of the fluid clutch in the clutch chamber. A bevel roller bearing is mounted in the center part of the transmission top plate. The transfer shaft from the clutch chamber is passing through the center hole of this bevel roller bearing to hold the transfer shaft. A roller bearing in the center part of the transmission is holding by a bearing case which is fixed on the lower plate of transmission. This roller bearing is guiding the center out put shaft. Another bevel roller bearing is mounted in the lower plate of the transmission. The center out put shaft is passing through the center hole of this bearing. The center driven bevel gear is connected to the out put shaft.

The Case of the Combination

This case is divided into 4 chambers. The chambers may connect by screw or by casting, chamber by chamber.

The Operation of this Combination

Description relating to the operation referred embodiments.

To put the gear in neutral gear position which is in the reverse and neutral gear chamber, to engage the brake drum 3, make the rotor 13 of dynamotor stay, and to turn the switch from the dynamotor to battery on, (not showed, in the circuit) the flywheel 42 will turn, so the engine will start. When the engine is started, if keep the brake drum 3 in engaging, the dynamotor will become a generator to give currant and charge the battery. When to disengage the brake drum 3, the rotor of the dynamotor will rote freely with the flywheel together by the surplus magnet. When to stop the engine, we engage the brake drum 4 to turn the switch on from the battery to dynamotor and he dynamotor will become a motor, to drive the car forward. When the reverse and neutral gear chamber 24 are in forward position, we shift the transmission in the 1^{st} gear position, to accelerate the engine or motor and the car will move forward.

I claim:

1. A Combination of Flywheel & Cylinder Internal Combustion Engine with Dynamotor, Clutch and Transmission may be used independently.

2. A combination as defined in claim 1., The F. & C. Engine, there is a cylinder head equipped with poppet valves. These valves are the exhaust valves, which are in two stroke cycle operation. Both inlet and exhaust valves are in four stroke cycle. A hole is provided for installing the nozzle or spark plug. It may cool by air or water.

3. A combination as defined in claim 1. The F. & C. Engine there is a cylinder, in the bottom of the cylinder are many inlet holes, to guide the air into the cylinder. Further to the bottom, there are some other holes, for inleting and outleting air in or out of this section of cylinder. This section of cylinder functions as an air compressor. The compressor is divided into two stages. The upper stage is to force air to get into a reservoir, the other into the cylinder of the engine, controlling by check valves.

4. A combination as defined in claim 1. The F. & C. Engine, there is a piston inside the said cylinder. It is perfect round and do not need an ellipse for it has no compression and explosion impacting surfaces. The pin adept full floating type and it may get much larger moving range.

5. A combination as defined in claim 1. The F. & C. Engine, there is a push rod. There is a hole at the upper end of this push rod, and a pin is passing through it to connect the piston. There is another hole at the lower end of this push rod and there is a flanged pin passing through it. This flanged pin is hollowed in order to tap threads in it, a smaller petal end. Inside the smaller petal end is a tapered hole with threads screw, and a tapered tip bolt is driving into this tapered and threaded hole to expend it and to fix the flanged pin. On the both ends of this flanged pin mounted a bearing respectively. The bearings are stretching and running inside the channel of the flywheel.

6. A combination as defined in claim 1. The F. & C. Engine, there is a flywheel. On the top of this flywheel is a top plate. In center of this plate mounted a hollowed center shaft. The outside of this center shaft mounted a bevel roller bearing, and the bearing is holt by the upper plate of the top plat of the Combination case. The inner of the center shaft mounted a bevel roller bearing. The center shaft of the dynamotor is passing through the center hole of this bearing. At further upper of this center shaft is fixed a brake drum. Outside of this brake drum is a set of brake band and bracket devices for controlling the brake. Around the circumference of the said flywheel to build two layer-wall (one layer may acceptable but the force is not in balance). In the out side of the inner wall and the inner side of the out wall, to carve a channel respectively, the channel may a curve or an inclined plane. For efficiency, the curve is higher than the inclined plane and downward bend curve is better than upward. At the center of the channels, to drill holes through the walls for installing the flanged pin. At the very beginning part of the curve or incline plane, there is a buffer. The buffer is used to reduce the impacting load when the curve or inclined plane is too steep. There is a bottom plate of the flywheel, on the center part mounted a short center shaft, and on the lower part of this shaft is hollowed. In the hollowed part to hold an overdrive clutch, (a single direction bearing), and a transfer shaft from the reverse and neutral gear chamber is passing through the center hole of this overdrive clutch. The upper part of this transfer shaft from the reverse and neutral gear chamber is hollowed, and inside this hollow part hold another overdrive clutch. The center shaft of the dynamotor is passing the center hole of this overdrive clutch. Many supporting rollers they are distance faraway from the center are mounted under the lower plate of flywheel for supporting the flywheel.

7. A. combination as defined in claim 1. The F. & C. Engine, there is a guide plate with numbers (same numbers of the cylinders) of channels to contain the push rod and guide in its position. This guide plate is mounted on the top plate of the Engine and Dynamotor chamber.

8. A combination as defined in claim 1. The dynamotor, there is a rotor with a center shaft passing through the center of the rotor. On the upper part of this center shaft there is a commutator. Near the top of the rotor, on the out side of the commutator, is a set of carbon brush and its bracket mounted on the top plate of the Engine and the Dynamotor chamber. Passing a center hole of a bearing, the further upper part of this center shaft is mounted a brake drum. A set of band and bracket is mounted on the upper cover of the Engine and Dynamotor chamber, for controlling the brake drum. The lower part of this center shaft is passing through the center hole of the overdrive clutch and a supporting bearing. The field of this Dynamotor is mounted on the inner wall of the flywheel.

9. A combination as defined in claim 1. The reverse and neutral gear chamber, in this chamber is contained a gear built on the lower end of the transfer shaft. From this chamber to the overdrive clutch, there is a two-end gear. One end of this gear is engaged in the gear built on the transfer shaft and the other end of this gear is engaged in an idler. The idler is engaged with the slide gear. When the slide gear is in the reverse gear position, the slide gear is mounted on the gear built on the transfer shaft from the clutch chamber. When the slide gear is not engage any gear, it is in the neutral gear. When the slide gear is engaged in the both gears are built on transfer shaft from over drive clutch and the clutch chamber is in the forward gear.

10. A combination as defined in claim 1. The Clutch chamber, in this chamber contains a group of fluid clutch. The upper piece of this clutch mounted on the transfer shaft from the reverse and neutral gear chamber, and the lower piece of this clutch is mounted on the transfer shaft from the Transmission.

11. ,A combination as defined in claim 1. The Transmission. This transmission may operate automatically or manually. There are many bevel gears with brake drums or ratchet wheels encased together, to control the brake drum or the ratchet wheel, and to shift the speed. From center toward outward is the speed from lower to higher. A transfer shaft from the clutch chamber is driving a bracket with axes. On the axes fixed many small pinion bevel gears. The small pinion bevel gears, among which is near the center is meshed with a center bevel gear which built on the top of the output shaft, is driving the this center shaft to put out work. The center bevel gear and the out put shaft are in one body.

12. A combination defined as in claim 1. It is a combination case. This case may divide into many chambers. In the top plate of this case, many holes are placed for mounting cylinders and bearings or other necessary accessories. The bottom of this case may equip with many legs, which support the whole case.
